(19) United States
(12) Patent Application Publication
(10) Pub. No.: US 2012/0265635 A1
(43) Pub. Date: Oct. 18, 2012

(54) SOCIAL NETWORK RECOMMENDATION POLLING

(76) Inventor: Nils Forsblom, La Quinta, CA (US)

(21) Appl. No.: 13/087,172

(22) Filed: Apr. 14, 2011

(51) Int. Cl. G06Q 30/00

(52) U.S. Cl. 705/26.7

(57) ABSTRACT

The generating of a purchase decision recommendation for a primary user from a plurality of polled users is disclosed. Selections of a plurality of products from the primary user are received, and a selection of the polled users is received. A poll for the purchase decision recommendation is generated, which may include a listing of product entries corresponding to the received selection of the plurality of products. There is a step of transmitting response requests for the poll to the selected polled users. Upon receiving a ballot entry corresponding to a selection of one or more of the product entries in the poll from at least one of the selected polled users, the purchase decision recommendation is generated, based upon an aggregation of the received ballot entries.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to online social networking services and electronic commerce. More particularly, the present disclosure relates to social network recommendation polling for assisting in purchasing decisions.

2. Related Art

Online, web-based social networking services are popular across a wide demographic of users, and the field in general is experiencing substantial growth. At the most basic level, social networking involves connecting users with each other to communicate and share information. Users typically establish accounts and create profiles containing biographic data such as current location, schools attended, employment experiences, personal relationships, and so forth. Furthermore, various updates of interest with messages, photographs, videos, and links to other sites may be posted on the profile. Access to this personal information may be limited to others that have approved and set up links with the user account. Depending on preference, information of limited privacy concern may be made accessible to secondary contact links, or to all users on the social networking service. A group of contacts, which can mirror the user's real-life personal network, may thus be established online, and a variety of content can be exchanged.

There are a many social networking sites currently online, and beyond basic networking and messaging functionalities, may be configured for specific purposes and uses. For example, services such LinkedIn is targeted for business-oriented uses in which users post relevant employment-related content, whereas services such as Facebook and MySpace are geared more toward social and entertainment uses. Furthermore, services such as Twitter provide “live-update” type features, and services such as FourSquare contemplates location-based updates.

While social networking is rapidly gaining a significant share of Internet usage, perhaps one of the most common uses is online shopping for goods and services, otherwise referred to as e-commerce. This is likely so because of the convenience, ready availability of information for purchase decision-making, lower prices, and a wide selection of products. Generally, a customer visits a merchant's website, which have visual representations of the products being sold, along with descriptions thereof. The visual appearance and interactive features are designed to mimic, as closely as possible, the actual experience of shopping in physical stores. After selecting the desired goods and recording the same into a shopping cart, the customer exchanges payment information with the merchant website. Upon successful payment processing, the merchant delivers the ordered product(s).

For many purchases, particularly when the product is being purchased online, customers undertake a significant amount of research prior to making a decision. Most merchant websites have the functionality to receive and display feedback and ratings for each product being sold, and one aspect of this research is the perusal thereof. With information provided by the merchant, as well as the feedback from earlier purchasers, the customer is empowered to make better decisions than ever before.

However, online shopping, and traditional shopping at a physical store for that matter, is generally a solitary activity. Even when joined by companions, there are usually no more than two or three additional participants. Thus, despite the availability of reviews and other valuable information, the analysis and decision-making process to purchase the item lies solely with the purchaser, and with limited assistance. The authors of the review may have a different perspective that may be different from that of the prospective purchaser, such that the product, while being suitable for the former, may not be for the latter. For some classes of products such as fashion items, the purchase decision may depend largely on taste and other intangible factors. Opinions received from those familiar with the customer such as family, friends and colleagues may prove to be the most helpful.

Accordingly, there is a need in the art for leveraging the user base of existing social networks to assist with making purchasing decisions.

### BRIEF SUMMARY

The present disclosure contemplates a method of generating a purchase decision recommendation for a primary user from a plurality of polled users. The method may begin with receiving selections of a plurality of products from the primary user. The selections may be associated with the purchase decision recommendation. Additionally, the method may include receiving a selection of the polled users. There may also be a step of generating a poll for the purchase decision recommendation, which may include a listing of product entries corresponding to the received selection of the plurality of products. Thereafter the method may continue with transmitting response requests for the poll to the selected polled users. There may be a step of receiving a ballot entry from at least one of the selected polled users. The ballot entry may correspond to a selection of one or more of the product entries in the poll. The method may include a step of generating the purchase decision recommendation based upon an aggregation of the received ballot entries. The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram showing an exemplary networked computing environment including a social networking website and an online shopping website in which various embodiments of the present disclosure may be implemented;

FIG. 2 is an example product catalog generated by the online shopping/merchant site;

FIG. 3 is a flowchart illustrating one embodiment of a method of generating a purchase decision recommendation;

FIG. 4 is an example product comparison page generated in accordance with various embodiments of the method of generating purchase decision recommendations;

FIG. 5 is an example poll selection page generated for identifying the users from which the purchase decision recommendation is requested;

FIG. 6 is an example poll page generated for making purchase decision recommendations; and

FIG. 7 is an example results page with the purchase decision recommendation.

Common reference numerals are used throughout the drawings and the detailed description to indicate the same elements.

### DETAILED DESCRIPTION

The present disclosure contemplates various embodiments for generating a purchase decision recommendation for a primary user from a plurality of polled users. From a selection of multiple products, opinions from friends and/or online communities can be considered in order to make a purchase decision. In this regard, various methods that may be implemented as executable software instructions are specified. The detailed description set forth below in connection with the appended drawings is intended as a description of the presently contemplated embodiments of these methods, and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

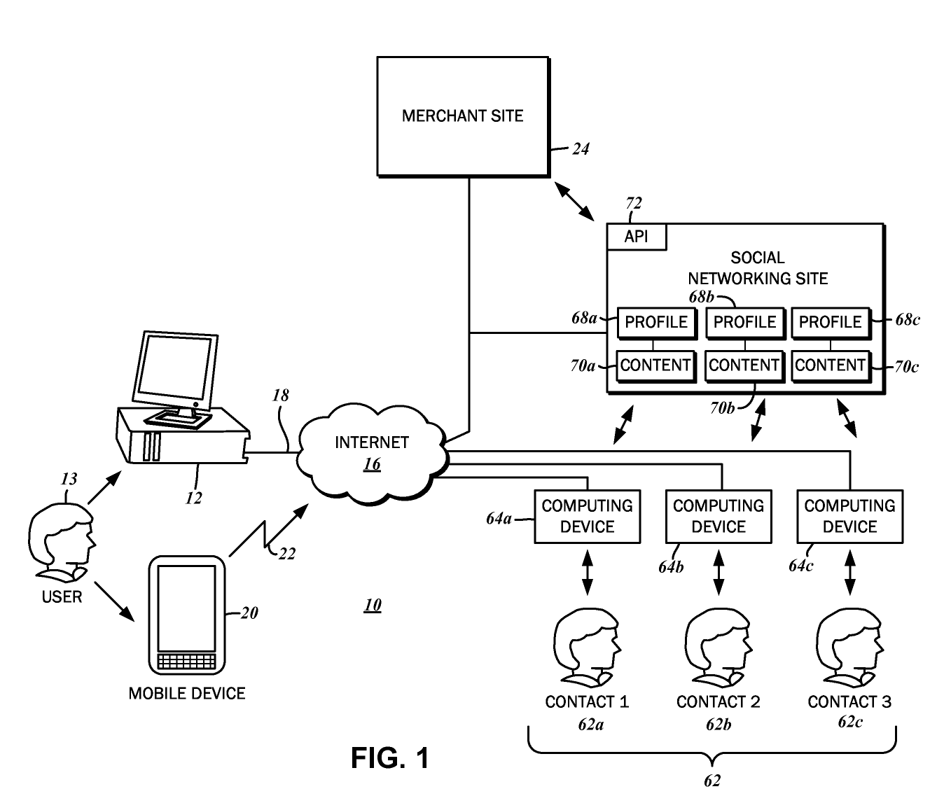

FIG. 1 depicts one exemplary embodiment of a networked computing environment 10 where various embodiments of the social network recommendation polling methods and systems may be implemented. Although specific components thereof are described, those having ordinary skill in the art will recognize that any other suitable component may be substituted. One component is a client computer system 12 operated by a primary user 14. The client computer system 12 may be a conventional personal computer device including a central processing unit, memory, and various input and output devices such as keyboards, mice, and display units. The client computer system 12 is connectible to the global Internet 16 via an Internet link 18.

Some embodiments can utilize a mobile device 20 that is likewise connectible to the Internet 16 via a wireless Internet link 22. As will be discussed in greater detail below, invocation of the social network polling system and method need not be restricted to be from a set physical location as may be the case with the client computer system 12. It may be utilized, for example, while shopping at conventional “brick and mortar” stores. Untethered data communication modalities such as the mobile device 20 make this possible, and examples thereof include cellular phones, smart phones, and tablet computing devices.

The mobile device 20 and the client computer system 12 are understood to have similar features, in particular, executable instructions of a web browser application that are loaded thereon. The web browser application communicates with various web servers also connected to the Internet 16 over the hypertext transfer protocol (HTTP), among others protocols known in the art. Requests for data are initiated by the mobile device 20 or the client computer system 12 and transmitted to the servers, while the server transmits the requested data to the mobile device 20 or the client computer system 12. For purposes of the present disclosure, the mobile device 20 will be referenced as a specific kind of the client computer system 12, and thus the terms are, for the most part, interchangeable. Where features specifically relevant to the mobile device 20 are being discussed, it will be referenced thus.

The networked computing environment includes a merchant site 24 that is also connected to the Internet 16. Generally, the merchant site 24 is associated with a retailer that maintains an inventory of various products being sold. However, the merchant site 24 may be associated with multiple retailers/merchants. The specific business arrangements of the merchant site 24 may differ among specific implementations, and generally, any web site that sells products to the primary user 14 is understood to be encompassed. A catalog 26 of the inventory of the merchant(s) may be generated for browsing on the client computer system 12. It will be recognized that the catalog 26 can be presented in a variety of different ways and visual embellishments that fit the brand identity of the retailer.

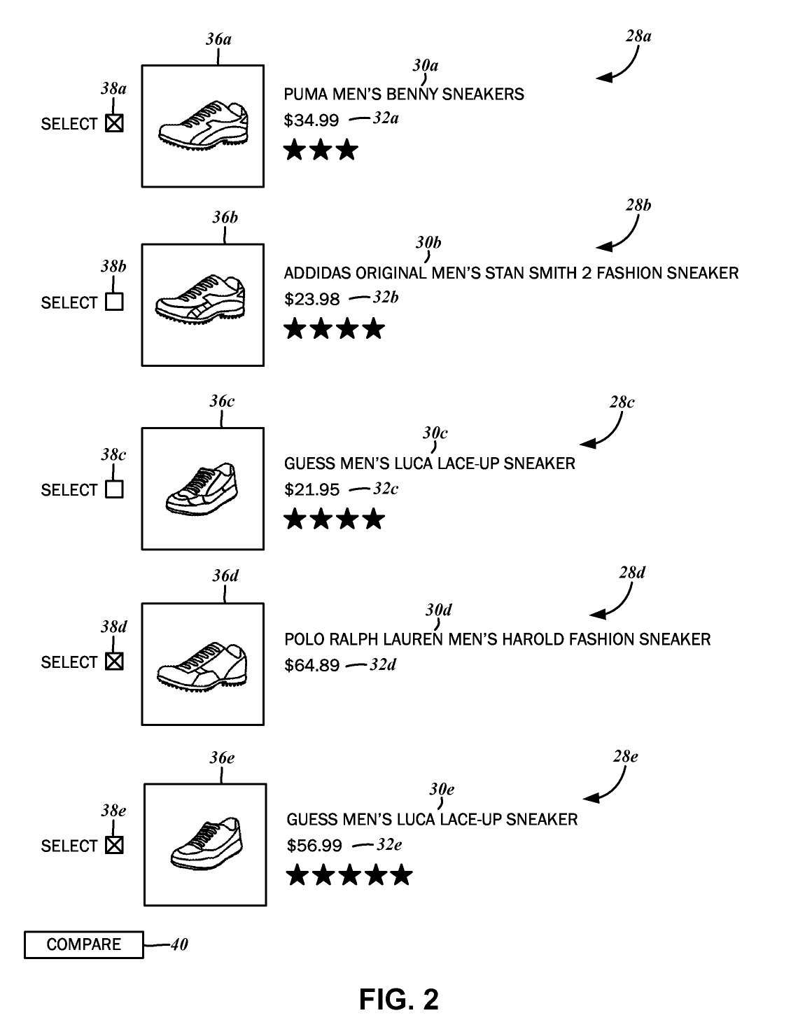

In its most basic form shown in FIG. 2, an example implementation of the catalog 26 is a listing of certain sneakers in the inventory of the retailer. There is shown five catalog entries 28a-28e, with each entry having a corresponding brief product descriptor field 30a-30e, and price field 32a-32e. In some cases, particularly catalog entries 28a, 28b, 28c, and 28e, there is a rating field 34a, 34b, 34c, and 34e, respectively, which may be an aggregate of ratings that have been received from other users. Each of the catalog entries 28a-28e also includes pictures 36a-36e, respectively, which visually depict the corresponding products. The brief product descriptor field 30 and/or the picture 36 are hyperlinked, in that clicking such hyperlinks are operative to retrieve a details page that includes additional information of the product. The catalog 26 and its contents are presented by way of example only and not of limitation, and any other suitable arrangement of content and user interface elements may be readily substituted. Along these lines, there are several ways in which primary user 14 can navigate to the catalog 26 as presented in FIG. 2, including inputting search commands, narrowing the length of the product listings by selecting merchandise categories, and so forth.

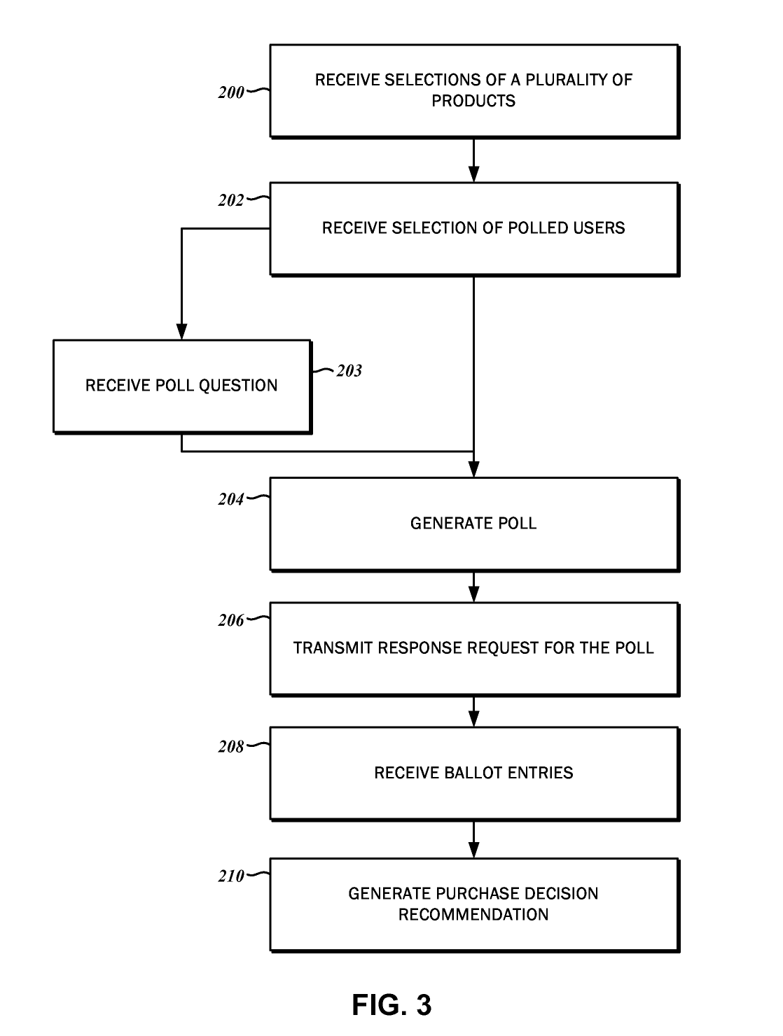

The catalog 26 and the merchant site 24 may also include various online shopping features such as adding selected items to a cart, checking out/rendering payment, and so forth. Additionally, the catalog 26 may have the functionality of presenting selected items therein in a specific arrangement suitable for the primary user 14 to make comparisons. The contemplated method for of generating a purchase decision recommendation may employ this functionality as a preliminary step. With reference to the flowchart of FIG. 3, the method begins with a step 200 of receiving from the primary user 14 selections of a plurality of products that are to be associated with the purchase decision recommendation. One way this selection may be made from the catalog 26 is by activating one or more of the checkboxes 38a-38e, each of which correspond to the respective one of the catalog entries 28a-28e. In the illustrated example, checkboxes 38a, 38d, and 38e have been activated, representative of selecting a first product or catalog entry 28a, a fourth product or catalog entry 28d, and a fifth product or catalog entry 28e. Besides the checkboxes 38, there may be other ways for making product selections. For example, recent designs of online shopping websites utilize scripts that capture user input or mouse clicks in the general area of the catalog entry 28, with background colors being changed in response to indicate selection.

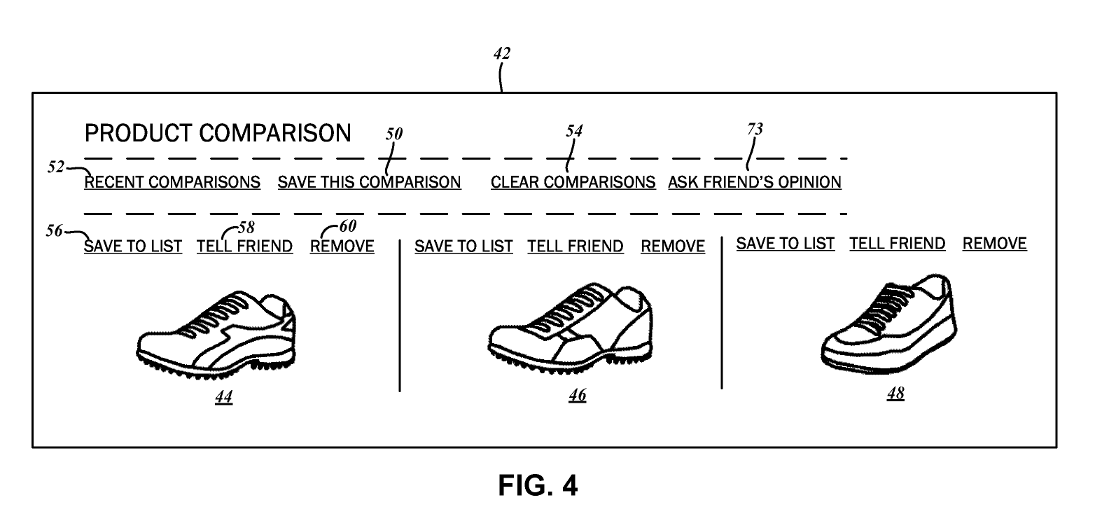

After making the desired selections of products, the primary user 14 may activate a compare button 40 to save the selections and continue with the method. FIG. 4 best illustrates a comparison page 42 that shows the selections of the products that were made. The comparison page 42 is segregated into three sections, with a first section 44 showing the first picture 36a, a second section 46 showing the fourth picture 36d, and a third section 48 showing the fifth picture 36e. The selections shown in the comparison page 42 is understood to be a part of one set; many different sets of products may also be maintained. Accordingly, the comparison page 42 includes functionality to save the currently shown set of selections, which is activated via a save hyperlink 50. There is also a related functionality of retrieving recent selection sets, activated via a retrieve hyperlink 52, and a functionality of clearing the currently shown selection set that is activated by a clear hyperlink 54. Further, each of the first section 44, the second section 46, and the third section 48 include activatable functions that are specific to pertinent catalog entries 28a, 28d, and 28e. These functions include saving the product to a list, which is activated by a hyperlink 56, sending a link for the catalog entry 28 to a specified recipient, which is activated by a hyperlink 58, and removing the catalog entry 28 from the comparison set, which is activated by a hyperlink 60.

The functionality of the comparison page 42 and the specific embodiment of the step 200 discussed above is understood to be managed by the merchant site 24 and dependent thereon. However, there are alternative embodiments contemplated in which the selection of products for comparison and generating purchase decision recommendations is independent of the merchant site 24, or any other merchant site. As briefly indicated above, it is possible to employ this functionality outside of the online shopping context, for example, while shopping at conventional “brick and mortar” stores.

A standalone software application may be running on the mobile device 20. As the primary user 14 browses from store to store, several desirable alternatives for a product may be identified. Whenever a desirable product is encountered, the primary user 14 takes a picture of the same with the on-board camera of the mobile device 20. A comparison page like that described above may be generated on the mobile application following the input of the pictures and pertinent data such as the product name, price, retailer, and so forth. The specific way in which such data is entered may vary. One contemplated embodiment involves manual entry, though more sophisticated techniques such as bar code scanning, Q-code scanning, and the like may also be utilized. Further, it is possible to take photographs of the label, and with optical character recognition, the contents thereof may be derived. As will be explained more fully below, the opinions of an entire network of contacts associated with the primary user 14 may be leveraged to reach a purchase decision, greatly enhancing the otherwise solitary shopping experience.

Referring again to the flowchart of FIG. 2, the method continues with a step 202 of receiving a selection of polled users. The block diagram of FIG. 1 illustrates the primary user 14 having a network of contacts 62 including a first contact 62a, a second contact 62b, and a third contact 62c, for example. Each of the contacts 62 accesses the Internet 16 via a computing device 64, which is similar to the client computer system 12. Broadly, the present disclosure contemplates the primary user 14 requesting opinions from the contacts 62 to make a purchase decision, and further details of this functionality will be described more fully below.

In one embodiment, the contacts 62 each have an account with a social networking site 66. As indicated above, numerous social network services are known in the art. Each generally provides a different user experience, while some key aspects are shared. These commonalities include a viewable profile 68 containing biographic information and other user-generated content 70, as well as the capability of linking to other accounts or profiles. Furthermore, interactive communications between profiles can be facilitated in public, semi-private, and private settings. In the example shown, the primary user 14 is linked to the accounts associated with the contacts 62a-62c, such that content posted to the profile of the primary user 14 is viewable thereby. Depending on the social networking service, the feature of posting user-generated content may be variously referred to as a “wall,” a “stream” or the like. It is expressly contemplated that any social networking service may be utilized in connection with various embodiments of the present disclosure, including the previously mentioned Facebook, Myspace, Friendster, etc.

The profile data, including all content 70 associated therewith, as well as the links or associations to other accounts/profiles, is stored and managed by the social networking site 66. This data may be accessed by third party application providers at the direction of users via an application programming interface (API) 72 to provide enhanced functionality to the third party site, or to generate content that is added to the profile.

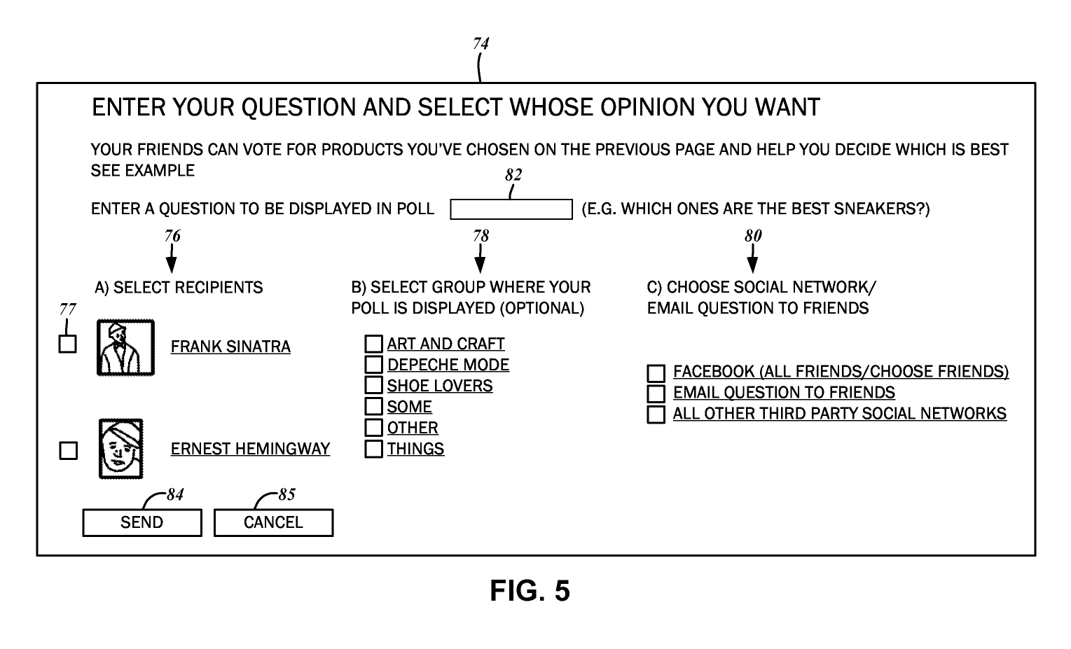

The aforementioned step 202 of receiving the selection of the polled users is best illustrated in the example poll selection screen 74 of FIG. 5. Earlier, with reference to FIG. 4, following step 200 of receiving selections of products, an “ask for opinion” hyperlink 73 in the comparison page 42 can be invoked. It is contemplated that the poll selection screen 74 is used by the primary user 14 to specify the contacts 62 to which the purchase decision recommendation question is directed.

With certain implementations of the merchant site 24, some of the contacts 62 may have established accounts as the primary user 14 has. In a first section 76, these contacts 62 are listed, and can be selected by activating a checkbox 77. Before being listed in this manner, these contacts 62 may first be validated in a procedure similar to that utilized in conventional social networking systems.

Aside from the basic cataloging and shopping functions mentioned above, the merchant site 24 may host groups of customers who share similar tastes and interests. For example, a separate section of the website may be customized for the members of such groups with special pricing, new product announcements, and so forth. The merchant site 24 may also host a discussion forum for the group members. The poll selection screen 74 may thus include a second section 78 where the groups to which the purchase decision recommendation question is directed, is specified. Again, the checkboxes 77 may be used to make these selections.

Instead of, or in addition to the contacts managed by the merchant site 24, contacts linked to the primary user 14 externally, such as conventional e-mail and various social networking sites 66 may also be selected from the poll selection screen 74. There is a third section 80 in which these selections may be made. Like the other sections, the checkboxes 77 may be used to make the selections. As shown in FIG. 3, the option for Facebook contacts, e-mail contacts, and all other third party social networks are segregated. This is by way of example only, and any other selection hierarchy may be utilized.

Referring again to the flowchart of FIG. 3, the method may include an optional step 203 of receiving a poll question from the primary user 14. The poll selection screen 74 includes a poll question input box 82 where the poll question may be entered. It is contemplated that a more personalized experience is delivered and a more specific request is identified, i.e., “which ones are the best sneakers for me?”

The foregoing steps of receiving the selection of polled users and the poll question are also a part of the previously noted standalone mobile application embodiment. Instead of the contacts 62 managed by the merchant site 24 being an option from which the purchase recommendation can be requested, contacts stored on the mobile device 20 may be selected, whether it be general thereto or specific to the standalone application. The contacts 62 from the social networking site 66, e-mail, and so forth discussed above remain selectable. Although the presentation may be varied to accommodate the different platform of the mobile device 20, the contents and the accessible functionality of the poll selection screen 74 may be similar to the one generated by the merchant site 24.

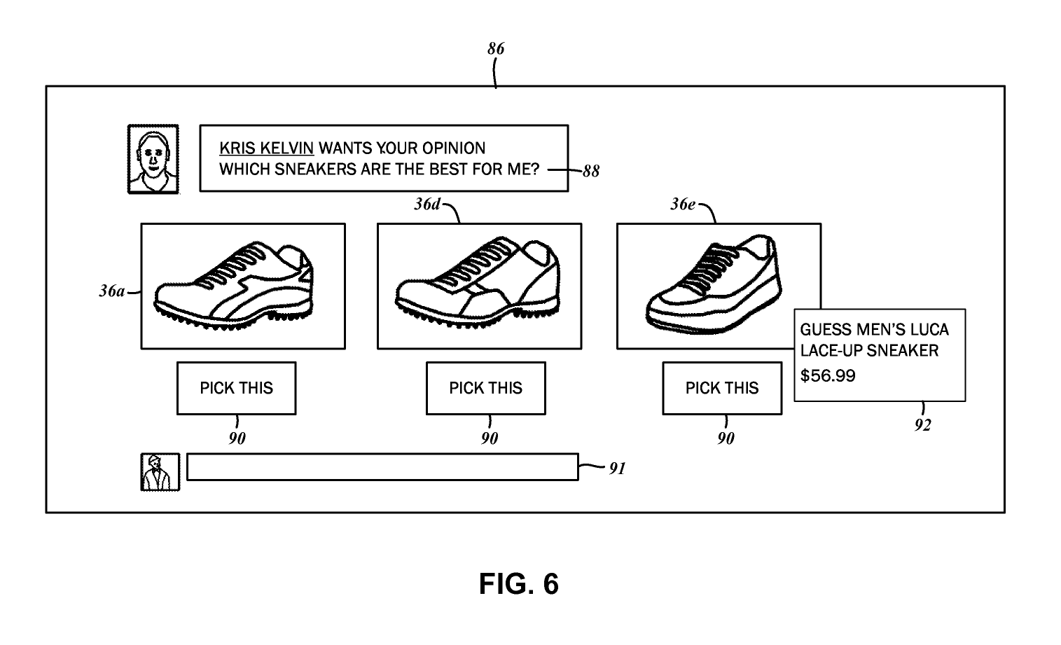

The method continues with a step 204 of generating a poll for the purchase decision recommendation. The poll may be generated in response to the primary user 14 activating a send button 84 on the poll selection screen 74. The subsequent steps of the method may be aborted via a cancel button 85. The poll includes the aforementioned listing of product or catalog entries 28 that have been selected for the poll in step 200, as discussed above. FIG. 6 best illustrates an example poll question page 86 that is generated, which includes the pictures 36a, 36d, and 38e, corresponding to the selected catalog entries 28a, 28d, and 28e. The inputted poll question 88 in step 203 is also displayed, as well as an identification of the primary user 14 that initiated the request. Underneath each of the pictures 36 is a ballot entry button 90 that indicates the preference of the polled users or selected contacts 62. Although in the example embodiment only one product is selectable, there may be other embodiments where ranking orders may be specified, or multiple selections may be made. Additionally, the poll question page 86 includes a comment input box 91, wherein more particular remarks can be made by the respondent. For example, comments that explain the rationale for any given choice may be entered, such as “these match more of your wardrobe colors,” etc. It will be recognized that the poll question page 86 may be presented in a variety of different ways, including the display of other pertinent information such as price, brand, and description in a pop-up element 92 when the cursor is positioned on or near either the ballot entry button 90 or the picture 36.

Still referring to the flowchart of FIG. 2, the method continues with a step 206 of transmitting response requests for the poll to the selected polled users. Although the poll and the response request is referenced independently, it is understood that depending on the implementation specifics and functional coordination with the social networking site 66, these may both be embodied in the poll question page 86 discussed above. In one variation, the poll may be posted to a profile of the primary user 14 on the social networking site 66. An announcement to this effect may be visible to the contacts 62 who are following the updates of the primary user 14. Alternatively, visibility of the update, and in particular, the response request, may be limited to those selected polled users. In either case, the update message to the contacts 62 may be deemed the response request. In another variation, the poll may be posted to the profiles of the selected ones of the contacts 62. Here, the posted poll would include the response request. These different approaches to requesting a response may be replicated with other third party social networks. In the case of e-mailed requests, the poll may be generated on the social networking site 66, the merchant site 24, or a third party hosting site. The e-mail would then include a hyperlink to the polls hosted at those various locations, thus constituting a response request.

After transmitting the response requests, and as the contacts 62 enter responses in the manner discussed above via the poll page 86, the method continues with a step 208 of receiving a ballot entry. The ballot entry is retrieved from at least one of the selected polled users, and correspond to a selection of one of the products or catalog entries 28 included in the poll. Each of the ballot entries may be transmitted via e-mail to the primary user 14.

The ballot entries may be aggregated by the merchant site 24 or the social networking site 66. The method further includes a step 210 of generating the purchase decision recommendation that is based upon such aggregation. Once a purchase decision recommendation is reached, in whichever suitable form, it may likewise be transmitted to the primary user 14 via e-mail, or posted to the profile on the social networking site 66. In accordance with various embodiments of the present disclosure, the poll may be kept open for a predetermined period of time. Results of the aggregation may be generated following the close of the poll, or may be generated as the ballot entries are received.

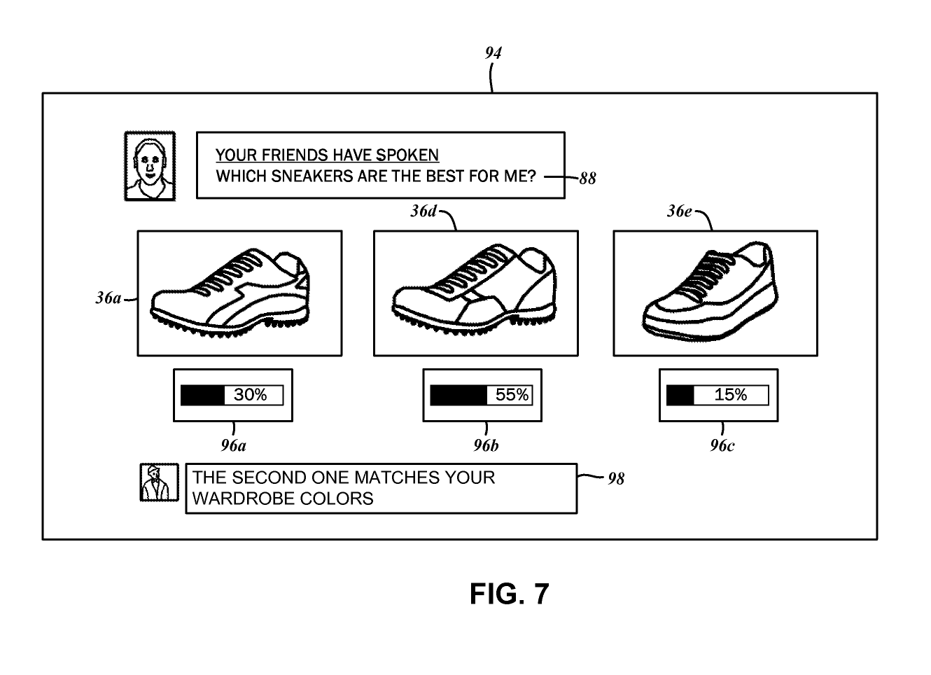

One way of presenting the purchase decision recommendation is shown in FIG. 7. In further detail, a results page 94 posted to the profile of the primary user 14 includes the same arrangement of the pictures 36a, 36d, and 36e, corresponding to the products that were initially selected for polling. Below each of the pictures 36, there is a tally display 94, with the first product garnering 30% of the ballot entries, the second product garnering 55% of the ballot entries, and the third product garnering 15% of the ballot entries. Although these values are expressed in terms of percentages of the overall ballot entries, it is also contemplated that the values can be expressed in terms of the number of ballot entries. Furthermore, remarks entered into the input box 91 may be shown beneath the tally displays 94 in a comment section 98.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present invention with more particularity than is necessary, the description taken with the drawings making apparent to those skilled in the art how the several forms of the present invention may be embodied in practice.

What is claimed is:

1. A method of generating a purchase decision recommendation for a primary user from a plurality of polled users, the method comprising:
receiving from the primary user selections of a plurality of products associated with the purchase decision recommendation;
receiving a selection of the polled users;
generating a poll for the purchase decision recommendation including a listing of product entries corresponding to the received selection of the plurality of products;
transmitting response requests for the poll to the selected polled users;
receiving a ballot entry from at least one of the selected polled users, the ballot entry corresponding to a selection of one or more of the product entries in the poll;
generating the purchase decision recommendation based upon an aggregation of the received ballot entries.

2. The method of claim 1, wherein each of the plurality of products is cataloged on one or more associated online merchant sites.

3. The method of claim 1, further comprising:
receiving from the primary user a poll question associated with the purchase decision recommendation;
wherein the poll includes the poll question.

4. The method of claim 1, further comprising:
receiving from the primary user one or more photographs of each of the plurality of products associated with the purchase decision recommendation;
wherein the product listing of the survey includes the one or more photographs.

5. The method of claim 4, wherein the one or more photographs of each of the plurality of products is received from a mobile device of the primary user.

6. The method of claim 1, wherein the response request is an announcement on an account of a social networking system associated with the primary user, the poll being viewable from accounts on the social networking system linked to the account of the primary user.

7. The method of claim 6, wherein the announcement is viewable from a selected subset of other accounts on the social networking system linked to the account of the primary user, the selected subset of other accounts corresponding to the received selection of the polled users.

8. The method of claim 6, wherein the response request is an announcement generated on a second account of a second social networking system associated with the primary user, the poll being viewable from accounts on the second social network system linked to the second account.

9. The method of claim 1, wherein the response request is an e-mail message transmitted to the selected polled users.

10. The method of claim 1, wherein the purchase decision recommendation is generated following the conclusion of a predetermined polling period, ballot entries received during the polling period being included in the aggregation.

11. The method of claim 1, wherein the purchase decision recommendation is updated with each received ballot entry.

12. The method of claim 1, wherein the purchase decision recommendation is generated on an account of a social networking system of the primary user.

13. The method of claim 1, further comprising:
transmitting the purchase decision recommendation to the primary user.

14. An article of manufacture comprising a program storage medium readable by a computer, the medium tangibly embodying one or more programs of instructions executable by the computer to perform a method of generating a purchase decision recommendation for a primary user from a plurality of polled users, the method comprising:
receiving from the primary user selections of a plurality of products associated with the purchase decision recommendation;
receiving a selection of the polled users;
generating a poll for the purchase decision recommendation including a listing of product entries corresponding to the received selection of the plurality of products;
transmitting response requests for the survey to the selected polled users;
receiving a ballot entry from at least one of the selected polled users, the ballot entry corresponding to a selection of one or more of the product entries in the poll;
generating the purchase decision recommendation based upon an aggregation of the received ballot entries.

15. The article of manufacture of claim 14, wherein the response request is an announcement on an account of a social networking system associated with the primary user, the poll being viewable from accounts on the social networking system linked to the account of the primary user.

16. The article of manufacture of claim 14, wherein the response request is an e-mail message transmitted to the selected polled users.

17. The article of manufacture of claim 14, wherein the purchase decision recommendation is generated on an account of a social networking system of the primary user.

18. The article of manufacture of claim 14, wherein the method further comprises:
transmitting the purchase decision recommendation to the primary user.

19. The article of manufacture of claim 14, wherein the one or more programs of instruction are executed on a mobile device of the primary user.
